(19) United States
(12) Patent Application Publication
(10) Pub. No.: US 2024/0171121 A1
(43) Pub. Date: May 23, 2024

(54) PV System Tracker Angle Optimization Using I-V Measurement

(71) Applicants: Michael Gostein, Austin, TX (US); William Stueve, Austin, TX (US)

(72) Inventors: Michael Gostein, Austin, TX (US); William Stueve, Austin, TX (US)

(21) Appl. No.: 18/514,646

(22) Filed: Nov. 20, 2023

Related U.S. Application Data
(60) Provisional application No. 63/427,506, filed on Nov. 23, 2022.

(51) Int. Cl. H02S 20/32; H02S 50/10

(52) U.S. Cl. CPC H02S 20/32; H02S 50/10

(57) ABSTRACT

In one respect, disclosed is a system for optimizing the orientation of a tracking system for PV modules, comprising: a current-voltage (I-V) measurement device configured to measure I-V data of at least one module within or disposed nearby a PV module string; and a controller configured to vary said orientation of said tracking system by means of an actuator while acquiring I-V curve data from said I-V measurement device, analyze said I-V data and therefrom determine an optimal orientation, and set said actuator to achieve said optimal orientation. In another respect, disclosed is a method for optimizing the orientation of a tracking system for PV modules, comprising: varying an orientation of said tracking system by means of an actuator, acquiring I-V data from a PV module within or nearby a PV module string on said tracking system using an I-V measurement device, analyzing said I-V data versus said orientation to determine an optimal orientation, and controlling said actuator to achieve said optimal orientation.

### CROSS-REFERENCE TO RELATED APPLICATIONS

This application claims the benefit of U.S. Provisional Patent Application 63/427,506 filed on 23 Nov. 2022, which is hereby incorporated by reference.

### STATEMENT OF GOVERNMENT INTEREST

Not applicable.

### FIELD OF THE INVENTION

The disclosed subject matter is directed to the optimization of orientation angles of tracking systems used in photovoltaic (PV) power plants.

### SUMMARY

In one respect, disclosed is a system for optimizing the orientation of a tracking system for PV modules, comprising: a current-voltage (I-V) measurement device configured to measure I-V data of at least one module within or nearby a PV module string; and a controller configured to vary said orientation of said tracking system by means of an actuator while acquiring I-V data from said I-V measurement device, analyze said I-V data and therefrom determine an optimal orientation, and set said actuator to achieve said optimal orientation.

In another respect, disclosed is a method for optimizing the orientation of a tracking system for PV modules, comprising: varying an orientation of said tracking system by means of an actuator, acquiring I-V data from a PV module within a PV module string on said tracking system using an I-V measurement device, analyzing said I-V data versus said orientation to determine an optimal orientation, and controlling said actuator to achieve said optimal orientation.

### BRIEF DESCRIPTION OF THE DRAWINGS

FIG. 1 depicts an exemplary string of PV modules (100) on an exemplary single-axis tracking system (105).

FIG. 2 depicts exemplary interconnections between various components in the exemplary embodiment of FIG. 1.

FIG. 3 depicts an exemplary integration of in-situ I-V system (120) into a control system.

### BACKGROUND

Photovoltaic (PV) modules, also known as solar panels, are used to produce energy in solar energy installations, also known as solar power plants or PV power plants. PV power plants are comprised of a PV array, which is an array of PV modules, together with power conversion equipment to utilize the power produced by the modules. Such power conversion equipment could include a load powered by the array, an inverter to convert the direct current (DC) power provided by the array to alternating current (AC) for immediate use or transmission, an energy storage system, or other equipment.

Some PV arrays utilize tracking systems to orient their PV modules to optimize power production. Single-axis tracking systems adjust only a tilt angle of the PV modules; dual-axis tracking systems adjust both a tilt and azimuthal angle.

PV modules may be characterized by an I-V curve, a relationship between PV module output current (I) and voltage (V), and parameters derived from the curve or associated with key points and values on the curve. Key points and values on the I-V curve include short-circuit current (Isc), open-circuit voltage (Voc), maximum power point (MPP), maximum power (Pmax or Pmpp), maximum power point voltage (Vmp), and maximum power point current (Imp). Other points and values of interest may also be defined. I-V characteristics of a PV module may include any of the values defined in the preceding, additional values and metrics, and/or the entire I-V curve. Collectively, any or all of these may be “I-V data.” Acquisition of I-V curves or subsets of I-V curves or I-V data may also be known as the performance of an I-V sweep.

Exemplary PV modules used in PV power plants have Isc between 2 amps and 30 amps, Voc between 20 volts and 300 volts, and Pmax between 20 W and 2000 W, when tested at standard test conditions (STC) corresponding to incident in-plane solar irradiance of 1000 W/m², module temperature of 25 degrees C., and air mass 1.5 (AM1.5) solar spectrum. Some modules used in PV power plants may have ratings outside these ranges.

Exemplary PV modules may be either monofacial, meaning that they respond to light from their front side only, or bifacial, meaning that they respond to light from both their front side and rear side. PV systems employing bifacial PV modules may have relatively higher electrical output versus monofacial PV systems—all other conditions being equal—due to their ability to respond to rear-side light, including light reflected from the ground towards the rear side of the PV modules as well as light from the sky which may reach the rear side of the PV modules under various conditions.

### DETAILED DESCRIPTION OF THE INVENTION

Disclosed herein is a system and a method for determining an optimal orientation of a tracking system for maximizing (or otherwise optimizing) power output in a PV power plant.

Tracking systems orient PV modules throughout the day to optimize power production as the solar position (elevation and azimuth of the sun in the sky) changes. Dual-axis tracking systems can orient PV modules to point directly towards the sun. Single-axis tracking systems typically have an axis aligned north-south and tilt PV modules from east to west throughout the day.

Determination of tracking system orientation may be performed by calculating the solar position at a given time and assuming that optimal power output occurs when minimizing the angle between rays from the sun and the normal to the PV module plane.

Other factors affecting optimal tracking system angle may also be considered, including the potential for row-to-row shading of PV modules at early and late hours in the day when the sun is low in the sky. Accordingly, the optimal orientation may be an orientation other than that which minimizes the angle between the PV module plane and rays coming directly from the sun.

When weather conditions are cloudy, additional factors may influence the optimal orientation of a PV tracking system. For example, in cloudy conditions when light from the sky is diffuse and the distribution of irradiance across the sky dome is substantially isotropic, it may be advantageous to direct the PV tracking system slightly away from the direction of the sun and towards a more vertical orientation, to receive more light diffused through the clouds. As another example, if the region of the sky containing the sun is darkened by clouds, but a neighboring region of the sky is brighter due to reflection from clouds, it may be advantageous to orient the PV module plane so that it is more closely (although not necessarily completely) perpendicular to rays coming from the neighboring brighter region of the sky.

For bifacial PV systems there may be additional factors influencing optimal orientation of a PV tracking system. Bifacial PV modules collect light from both front and rear sides. Rear side irradiance can depend sensitively on the amount of diffuse versus direct light in the sky, the position of the sun, the angle of the modules, the reflectivity of the ground surface, structural shading factors from module supports, and other factors. Total front plus rear irradiance may be maximized (or optimized) at an orientation other than that which places the modules perpendicular to rays coming directly from the sun.

Systems and methods are needed to identify the optimal orientation angle of a PV tracking system for given sky and other conditions.

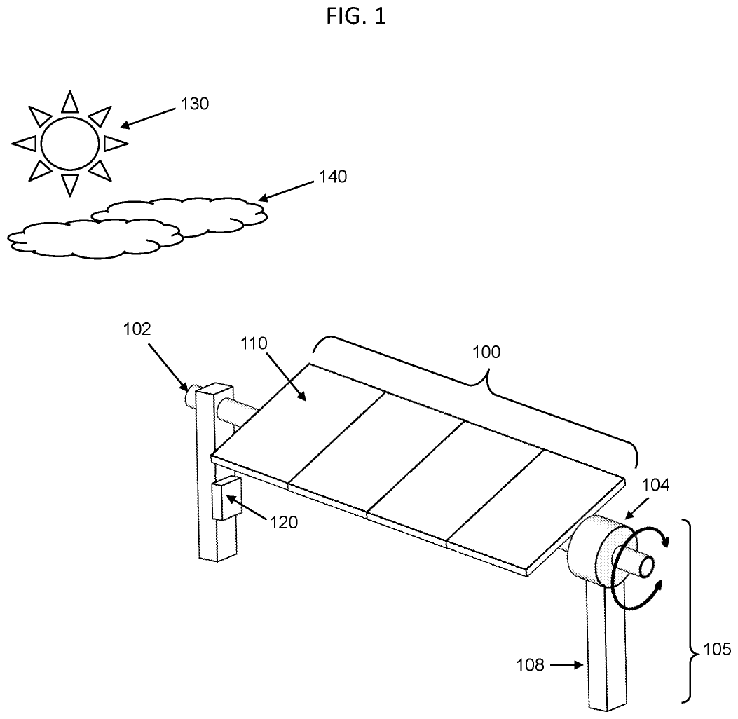

FIG. 1 depicts an exemplary string of PV modules (100) on an exemplary single-axis tracking system (105) comprising a support system (108), a torque tube (102), and an actuator (104). The string of PV modules (100) is mounted on the torque tube (102) which is rotated by actuator (104) throughout the day such that the tilt angle of the string of PV modules (100) is adjusted. Support system (108) holds the string of PV modules (100), torque tube (102), actuator (104), and other components. The depicted system is exemplary and actual systems may be organized differently. The number of PV modules in string (100) may vary. In other embodiments the tracking system (105) is a dual-axis tracking system instead of a single-axis tracking system.

In some conditions, clouds (140) may be present, potentially blocking rays from the sun (130) or potentially reflecting rays from the sun towards the ground, depending on the relative position of clouds (140) and sun (130).

In some embodiments PV modules (100, 110) may be monofacial or bifacial. In some embodiments employing bifacial PV modules (100, 110), contributions to total irradiance from the rear side of PV modules (100, 110) may be substantial, e.g., >1% of the total.

To identify the optimal orientation of the PV modules (100) on PV tracking system (105), in one embodiment, a reference PV module (110) from string of modules (100) is selected for measurement and connected to an I-V measurement system (120) which can periodically acquire I-V data from the selected PV module (110).

In some embodiments PV module (110) is standalone and is not electrically connected to string of PV modules (100).

In some embodiments PV module (110) is electrically connected to I-V measurement system (120) which therefore constitutes an in-situ I-V measurement system (120), capable of acquiring I-V data from PV module (110) while PV module (110) remains part of the string (100).

In some embodiments, in-situ I-V system (120) may be for example as described in U.S. Patent Application Publication US 2022-0360216 A1 or U.S. patent application Ser. No. 18/130,558 or U.S. Pat. No. 8,952,715, each of which is hereby incorporated by reference, or other similar implementations. In some embodiments in-situ I-V system (120) may periodically disconnect the PV module (110) from string (100), perform an I-V sweep, and reconnect PV module (110) to string (100). During the time that PV module (110) is disconnected, I-V system (120) may provide for a bypass which allows module string (100) current to pass through I-V system (120). In alternative embodiments I-V system (120) measures the I-V curve (also known as I-V sweep) of a module (110) without disconnection, for example by adjusting PV module (110) operating point using a DC-DC switching system, such as in a PV optimizer, and/or using internal loads.

Measurement of the I-V curve or subsets of an I-V curve (“I-V data”) allows determination of key electrical characteristics such as short-circuit current (Isc), maximum power (Pmax), open-circuit voltage (Voc), and others.

In some embodiments, I-V system (120) measures complete I-V curves ranging from nearly short-circuit to open-circuit or vice-versa, while in other embodiments I-V system (120) measures sub-portions of I-V curves, for example sufficient to determine Isc, Pmax, Voc, or other specific individual parameters, for example as described in U.S. patent application Ser. No. 17/739,823 or 18/130,558, each of which is incorporated herein by reference.

In some embodiments determination of Isc is used to determine an effective irradiance received by module (110). In some embodiments Pmax is used to determine a maximum potential power output of module (110).

Advantageously, using a standalone or in-situ I-V measurement system (120) (instead of, for example, a string (100) current monitor or inverter input monitor) allows measurements to assess the total potential output of a measured PV module, through its I-V curve or specific I-V curve parameters (I-V data), wherein said results are not limited to the actual power or current operating point of a PV module as it operates within a system, which may be limited by the string current of other modules with which it is in series or by an inverter or other power generation equipment, which may not be operating at maximum power point, e.g. due to clipping, curtailment, or other reasons.

Advantageously, using an in-situ I-V measurement system (120) (instead of, for example, I-V measurement on a standalone, disconnected PV module (110)) allows measurements to be performed while PV module (110) still contributes to total power/energy production of the PV array.

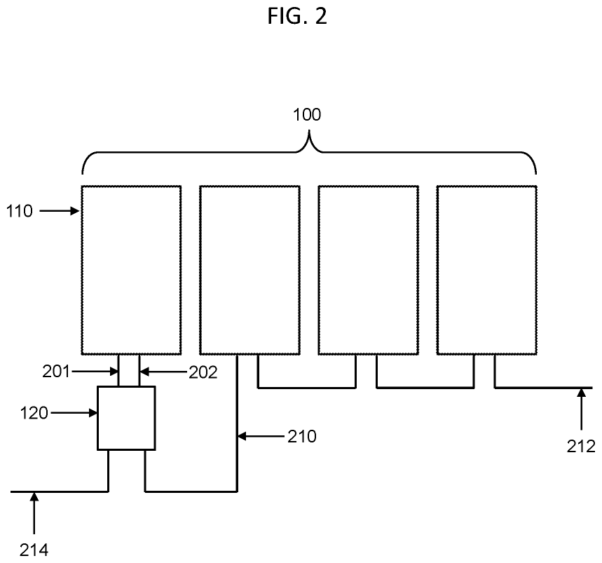

FIG. 2 depicts exemplary interconnections between various components in the exemplary embodiment of FIG. 1. PV module (110) is part of string of PV modules (100). Electrical leads (201, 202) of PV module (110) are connected to I-V system (120). The collection of electrical leads (210) connect I-V system (120) and PV module string (100) such that all members of string (100) are in series, including PV module (110). Leads (212, 214) at the end of the string (100) would be connected to a load or inverter or to additional strings in series and/or parallel combinations prior to connection to a load or inverter, as described in U.S. Patent Application Publication US 2022-0360216 A1 or U.S. patent application Ser. No. 18/130,558, both of which are hereby incorporated by reference.

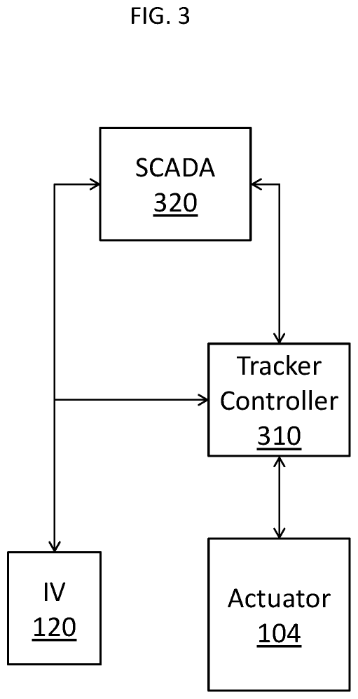

FIG. 3 depicts an exemplary integration of I-V system (120) into a control system. In one embodiment, a supervisory control and data acquisition system (SCADA) (320), a typical component of a utility-scale or commercial-scale PV power plant, communicates with I-V unit (120) and with a tracker controller (310) which controls actuator (104) that orients tracking system (105). SCADA system (320) uses data from I-V system (120) to determine optimal orientation, communicates this to tracker controller (310) which governs actuator (104) to adjust to the desired orientation. In another embodiment, tracker controller (310) communicates directly with I-V system (120) to obtain information necessary for determining optimal orientation and commanding actuator (104) to desired settings. In other embodiments I-V unit (120), SCADA (320), tracker controller (310), and/or actuator (104) are combined in alternative control schemes. SCADA (320) or tracker controller (310) are examples of controllers which may be used to implement the functions of this disclosure.

In one embodiment, a controller (SCADA system (320) or tracker controller (310)) determines optimal orientation of tracking system (105) by the following steps: scanning tracking system (105) through a range of angles; acquiring from I-V system (120) the PV module (110) power output (Pmax) or short-circuit current (Isc) at each angle; determining the angle with greatest value of Pmax or Isc, subject to other criteria of interest; and setting actuator (104) to achieve the desired angle. In some embodiments the forgoing steps are performed at regular intervals. In some embodiments a control system is configured to implement the preceding steps. In some embodiments a method implements the preceding steps.

In another embodiment, SCADA system (320) or tracker controller (310) determines optimal orientation of tracking system (105) by the following steps: acquiring using I-V system (120) the PV module (110) Pmax or Isc at a starting condition; offsetting tracking system (105) angle by a step value; acquiring PV module (120) Pmax or Isc at the new condition; determining whether Pmax or Isc has increased or decreased; selecting from between the starting condition and the step-offset condition whichever is more optimal, subject to other criteria; and setting actuator (104) to the optimal choice. In some embodiments a control system is configured to implement the preceding steps. In some embodiments a method implements the preceding steps. In some embodiments these steps are repeated either continuously or during set intervals.

In other embodiments, a control system is configured to implement other sequences of steps similar to those described or a method is arranged to implement other sequences of steps to identify optimal orientations, and these control systems and/or methods are intended to fall within the scope of this disclosure.

In some embodiments, an exemplary PV power plant comprises many rows of PV modules electrically connected in many strings. In some embodiments strings are arrayed on many separate tracking systems.

In some embodiments a system according to the disclosed invention, such as the exemplary systems depicted in FIG. 1, FIG. 2, and FIG. 3, operates on a small section of a PV power plant, comprising one or more PV modules (100), and the optimal orientation angle derived from this section is applied to additional sections.

In other embodiments, a system according to the disclosed invention, such as the exemplary systems depicted in FIG. 1, FIG. 2, and FIG. 3, is repeated on multiple sections through a PV power plant, so that each can be optimized independently. Independent optimization of multiple sections may be favorable, in some embodiments, when conditions between sections of a PV power plant are different, due to differences in ground terrain, ground reflectivity (albedo), instantaneous differences in cloud cover for large sites, or other factors.

1. A system for optimizing the orientation of a tracking system for PV modules, comprising:
a current-voltage (I-V) measurement device configured to measure I-V data of at least one module within a PV module string; and
a controller configured to
vary said orientation of said tracking system by means of an actuator while acquiring I-V data from said I-V measurement device,
analyze said I-V data and therefrom determining an optimal orientation,
and set said actuator to achieve said optimal orientation.

2. A method for optimizing the orientation of a tracking system for PV modules, comprising:
varying an orientation of said tracking system by means of an actuator,
acquiring I-V data from a PV module within a PV module string on said tracking system using an I-V measurement device,
analyzing said I-V data versus said orientation to determine an optimal orientation, and controlling said actuator to achieve said optimal orientation.
